(19) United States
(12) Patent Application Publication
(10) Pub. No.: US 2015/0354017 A1
(43) Pub. Date: Dec. 10, 2015

(54) METHODS FOR REMOVING RESIDUAL SOLIDS FROM ENZYMATIC HYDROLYSATE TO MAKE PURIFIED FERMENTABLE SUGAR SYRUP

(71) Applicant: API Intellectual Property Holdings, LLC, Atlanta, GA (US)

(72) Inventors: Ziyu WANG, Newnan, GA (US); Zheng DANG, Lilburn, GA (US); Mehmet Sefik TUNC, Thomaston, GA (US); Vesa PYLKKANEN, Atlanta, GA (US); Theodora RETSINA, Atlanta, GA (US)

(21) Appl. No.: 14/718,060

(22) Filed: May 20, 2015

Related U.S. Application Data
(60) Provisional application No. 62/009,206, filed on Jun. 7, 2014.

(51) Int. Cl. C13K 1/04

(52) U.S. Cl. CPC C13K 1/04

(57) ABSTRACT

The invention provides a method for purifying a biomass hydrolysate comprising sugars and suspended particles, comprising centrifuging the biomass hydrolysate, thermally treating the centrifuged hydrolysate to chemically or physically agglomerate the suspended particles, and filtering the thermally treated hydrolysate to remove agglomerated suspended particles, thereby generating a purified hydrolysate (sugar syrup). The sequence of steps may be varied. Biomass hydrolysates may be provided from a wide variety of processes. Surprisingly, a 20-fold improvement in sugar purity (total suspended solids content) is demonstrated experimentally, compared to prior methods.

### PRIORITY DATA

This patent application is a non-provisional application claiming priority to U.S. Provisional Patent App. No. 62/009,206, filed Jun. 7, 2014, which is hereby incorporated by reference herein.

### FIELD OF THE INVENTION

The present invention generally relates to improved processes for purifying fermentable sugars from lignocellulosic biomass.

### BACKGROUND OF THE INVENTION

Biomass refining (or biorefining), which separates cellulose, hemicellulose, and lignin from biomass feedstocks, is becoming more prevalent in industrial plants. Cellulose fibers and sugars are being used by many companies for chemical and fuel production. Indeed, we now are observing the commercialization of integrated biorefineries that are capable of processing incoming biomass much the same as petroleum refineries now process crude oil. Underutilized lignocellulosic biomass feedstocks have the potential to be much cheaper than petroleum, on a carbon basis, as well as much better from an environmental life-cycle standpoint.

Sugars obtained from lignocellulosic biomass can be fermented into various fuels and chemicals, but typically the sugars must be purified prior to fermentation. A common problem with sugar production from lignocellulosic materials lies in the separation of residual solids from the sugar syrup after enzymatic hydrolysis of pretreated biomass. Improved separation methods are desired.

### SUMMARY OF THE INVENTION

The present invention addresses the aforementioned needs in the art.

In some variations, the invention provides a method for purifying a biomass hydrolysate comprising sugars and suspended particles, the method comprising centrifuging the biomass hydrolysate to generate a centrifuged hydrolysate, thermally treating the centrifuged hydrolysate to chemically or physically agglomerate at least a portion of the suspended particles, thereby generating a thermally treated hydrolysate, and filtering the thermally treated hydrolysate to remove agglomerated suspended particles, thereby generating a purified hydrolysate comprising the sugars.

In some embodiments, the biomass hydrolysate is obtained from enzymatic hydrolysis of pretreated lignocellulosic biomass. The pretreated lignocellulosic biomass may be obtained from steam or liquid hot-water extraction of biomass, from fractionation of biomass in the presence of water, a solvent for lignin, and an acid, or other sources.

In some embodiments, the biomass hydrolysate is obtained from enzymatic or acidic hydrolysis of biomass-derived hemicelluloses. In certain embodiments, the biomass hydrolysate includes a first hydrolysate obtained from enzymatic hydrolysis of pretreated lignocellulosic biomass, and a second hydrolysate obtained from enzymatic or acidic hydrolysis of biomass-derived hemicelluloses. The biomass-derived hemicelluloses may be derived from the same source of biomass (i.e. same starting feedstock) as the pretreated lignocellulosic biomass.

Thermally treating may include heating the centrifuged hydrolysate at a treatment temperature selected from about 50° C. to about 200° C. for a treatment time selected from about 10 minutes to about 8 hours. In some embodiments, thermally treating includes heating the centrifuged hydrolysate at a treatment temperature selected from about 80° C. to about 120° C. for a treatment time selected from about 30 minutes to about 2 hours.

Optionally, the method further includes introducing an additive to the biomass hydrolysate, the thermally treated hydrolysate, or the centrifuged hydrolysate, to assist in agglomeration of the suspended particles.

Other variations provide a method for purifying a biomass hydrolysate comprising sugars and suspended particles, the method comprising thermally treating the biomass hydrolysate to chemically or physically agglomerate at least a portion of the suspended particles, thereby generating a thermally treated hydrolysate, centrifuging the thermally treated hydrolysate to generate a centrifuged hydrolysate, and filtering the centrifuged hydrolysate to remove agglomerated suspended particles, thereby generating a purified hydrolysate comprising the sugars.

In some embodiments, the biomass hydrolysate is obtained from enzymatic hydrolysis of pretreated lignocellulosic biomass. The pretreated lignocellulosic biomass may be obtained from steam or liquid hot-water extraction of biomass, from fractionation of biomass in the presence of water, a solvent for lignin, and an acid, or other sources.

In some embodiments, the biomass hydrolysate is obtained from enzymatic or acidic hydrolysis of biomass-derived hemicelluloses. In certain embodiments, the biomass hydrolysate includes a first hydrolysate obtained from enzymatic hydrolysis of pretreated lignocellulosic biomass, and a second hydrolysate obtained from enzymatic or acidic hydrolysis of biomass-derived hemicelluloses. The biomass-derived hemicelluloses may be derived from the same source of biomass (i.e. same starting feedstock) as the pretreated lignocellulosic biomass.

Thermally treating may include heating the centrifuged hydrolysate at a treatment temperature selected from about 50° C. to about 200° C. for a treatment time selected from about 10 minutes to about 8 hours. In some embodiments, thermally treating includes heating the centrifuged hydrolysate at a treatment temperature selected from about 80° C. to about 120° C. for a treatment time selected from about 30 minutes to about 2 hours.

Optionally, the method further includes introducing an additive to the biomass hydrolysate, the thermally treated hydrolysate, or the centrifuged hydrolysate, to assist in agglomeration of the suspended particles.

### BRIEF DESCRIPTION OF THE FIGURES

FIG. 1 is a simplified block-flow diagram depicting the process of some embodiments of the present invention.

FIG. 2 is a simplified block-flow diagram depicting the process of some embodiments of the present invention.

FIG. 3 includes photographs comparing biomass hydrolysates from conventional processing (left) and from an exemplary embodiment of the invention (right).

### DETAILED DESCRIPTION OF EMBODIMENTS OF THE INVENTION

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with any accompanying drawings.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs. All composition numbers and ranges based on percentages are weight percentages, unless indicated otherwise. All ranges of numbers or conditions are meant to encompass any specific value contained within the range, rounded to any suitable decimal point.

Unless otherwise indicated, all numbers expressing reaction conditions, stoichiometries, concentrations of components, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of.”

The present invention is premised on the surprising discovery of a convenient method to purify biomass hydrolysates. In some variations, the methods include removing residual suspended solids (including unhydrolyzed lignocellulosic biomass, lignin particles, ash, dirt, sand, and minerals, if any) from the sugar solution to obtain purified sugar syrup.

Without being bound by theory, it is believed that heating of enzymatic hydrolysate facilitates the subsequent filtration efficiency by agglomeration of fine particles that can be filtered out. The filtrate is purified fermentable sugar syrup with little or no suspended solids/salts in the syrup, as shown in the Example hereto. The separation method may alternatively, or additionally, include heating step prior to centrifugation, followed by filtration (or other separation techniques for final purification).

Certain exemplary embodiments of the invention will now be described. These embodiments are not intended to limit the scope of the invention as claimed. The order of steps may be varied, some steps may be omitted, and/or other steps may be added. Reference herein to first step, second step, etc. is for illustration purposes only. In the figures, dotted lines denote options streams and operations.

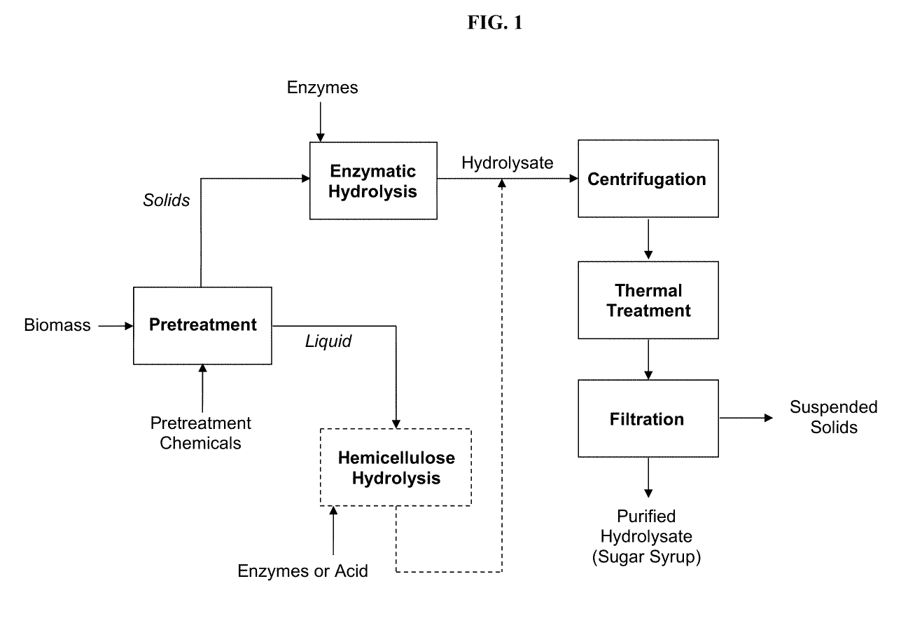

In some variations (see FIG. 1, for example), the invention provides a method for purifying a biomass hydrolysate comprising sugars and suspended particles, the method comprising centrifuging the biomass hydrolysate to generate a centrifuged hydrolysate, thermally treating the centrifuged hydrolysate to chemically or physically agglomerate at least a portion of the suspended particles, thereby generating a thermally treated hydrolysate, and filtering the thermally treated hydrolysate to remove agglomerated suspended particles, thereby generating a purified hydrolysate comprising the sugars. In some embodiments, following centrifugation, at least a portion of the solids are removed and not subjected to thermal treatment.

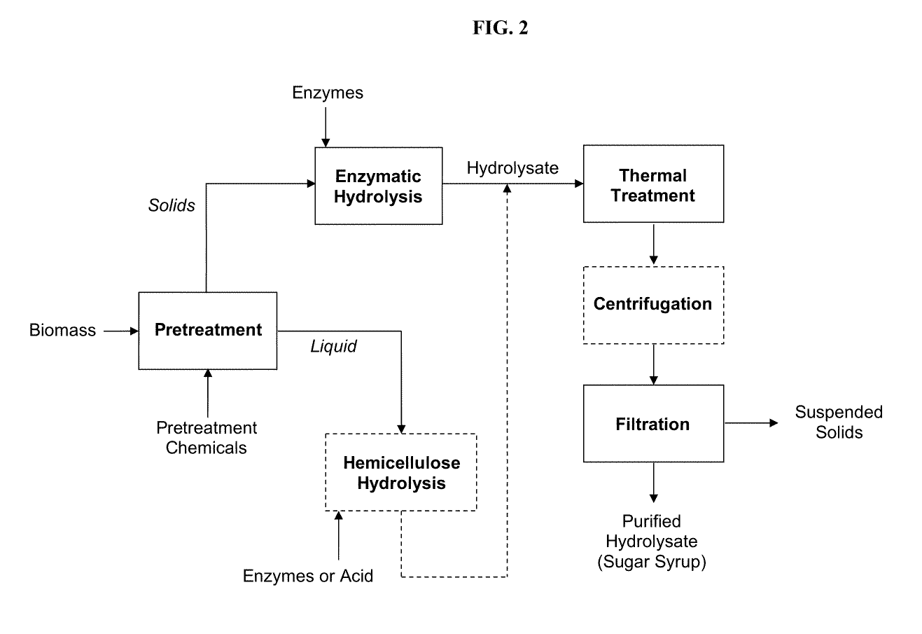

Other variations (see FIG. 2, for example) provide a method for purifying a biomass hydrolysate comprising sugars and suspended particles, the method comprising thermally treating the biomass hydrolysate to chemically or physically agglomerate at least a portion of the suspended particles, thereby generating a thermally treated hydrolysate, centrifuging the thermally treated hydrolysate to generate a centrifuged hydrolysate, and filtering the centrifuged hydrolysate to remove agglomerated suspended particles, thereby generating a purified hydrolysate comprising the sugars.

In some embodiments, the biomass hydrolysate is obtained from enzymatic hydrolysis of pretreated lignocellulosic biomass. The biomass hydrolysate may also be obtained from non-enzymatic, acidic or basic hydrolysis of pretreated lignocellulosic biomass. The pretreated lignocellulosic biomass may be obtained from steam or liquid hot-water extraction of biomass, from fractionation of biomass in the presence of water, a solvent for lignin, and an acid, or from other sources.

In certain embodiments, the pretreated lignocellulosic biomass is obtained from a Green Power+® process or a GP3+™ process, commonly owned with the assignee of this patent application. In certain embodiments, the pretreated lignocellulosic biomass is obtained from an AVAP® process, commonly owned with the assignee of this patent application.

In some embodiments, the biomass hydrolysate is obtained from enzymatic or acidic hydrolysis of biomass-derived hemicelluloses. In certain embodiments, the biomass hydrolysate includes a first hydrolysate obtained from enzymatic hydrolysis of pretreated lignocellulosic biomass, and a second hydrolysate obtained from enzymatic or acidic hydrolysis of biomass-derived hemicelluloses. The biomass-derived hemicelluloses may be derived from the same source of biomass (i.e. same starting feedstock) as the pretreated lignocellulosic biomass.

Thermally treating may include heating the centrifuged hydrolysate at a treatment temperature selected from about 50° C. to about 200° C., such as about 60° C., 70° C., 80° C., 90° C., 100° C., 110° C., 120° C., 130° C., 140° C., 150° C., 160° C., 170° C., 180° C., or 190° C. for a treatment time selected from about 10 minutes to about 8 hours, such as about 0.2, 0.4, 0.5, 0.8, 1, 1.5, 2, 2.5, 3, 4, 5, 6, or 7 hours. In some embodiments, thermally treating includes heating the centrifuged hydrolysate at a treatment temperature selected from about 80° C. to about 120° C. for a treatment time selected from about 30 minutes to about 2 hours.

Optionally, the method further includes introducing an additive to the biomass hydrolysate, the thermally treated hydrolysate, or the centrifuged hydrolysate, to assist in agglomeration of the suspended particles. Such additives may be used to adjust solution pH, ionic charge, polarity, viscosity, density, reactivity, or other parameters. Additives may be flocculants, binders, or other agglomeration agents.

Other variations integrate the centrifugation and thermal-treatment steps by centrifuging at an elevated temperature and for a sufficient period of time to accomplish thermal treatment. For example, a centrifugation temperature may be selected from about 50° C. to about 200° C., such as about 60° C., 70° C., 80° C., 90° C., 100° C., 110° C., 120° C., 130° C., 140° C., 150° C., 160° C., 170° C., 180° C., or 190° C. for a centrifugation time selected from about 10 minutes to about 8 hours, such as about 0.2, 0.4, 0.5, 0.8, 1, 1.5, 2, 2.5, 3, 4, 5, 6, or 7 hours.

The starting biomass feedstock may be selected from hardwoods, softwoods, forest residues, agricultural residues (such as sugarcane bagasse), industrial wastes, consumer wastes, or combinations thereof. Some embodiments of the invention utilize “agricultural residues,” which for present purposes is meant to include lignocellulosic biomass associated with food crops, annual grasses, energy crops, or other annually renewable feedstocks. Exemplary agricultural residues include, but are not limited to, corn stover, corn fiber, wheat straw, sugarcane bagasse, rice straw, oat straw, barley straw, miscanthus, energy cane, or combinations thereof.

The sugars may be recovered and fermented to a fermentation product, recovered and purified as a sugar product, or chemically converted to a sugar derivative (e.g., furfural), for example. In some embodiments, the fermentable sugars are fermented to produce of biochemicals or biofuels such as (but by no means limited to) ethanol, 1-butanol, isobutanol, acetic acid, lactic acid, or any other fermentation products. A purified fermentation product may be produced by distilling the fermentation product, which will also generate a distillation bottoms stream containing residual solids. A bottoms evaporation stage may be used, to produce residual solids.

In some embodiments, the fermentable sugars are recovered from solution, in purified form, or obtained as a purified sugar syrup.

The suspended solids that are removed from the system may be recovered for combustion (energy production) or for other uses. In some embodiments, the suspended solids include lignin. Note that in this disclosure, lignin includes not only precipitated lignin or chemically condensed lignin but also suspended lignin that physically scales or clogs pipes, pumps, reactor walls, etc.

### Example

In this Example, modified methods incorporating centrifugation followed by heating which is then followed by filtration were compared with conventional methods that include only centrifugation and filtration.

A biomass hydrolysate is obtained from enzymatic hydrolysis using cellulase enzymes on AVAP®-pretreated biomass (see, for example, U.S. Pat. No. 8,030,039 for a description of AVAP® technology in some embodiments).

The biomass hydrolysate is centrifuged at 10,000 rpm. Then the hydrolysate is heated at 80-120° C. for 0.5 to 2 hours. Finally, the hydrolysate is filtered using conventional laboratory filtration.

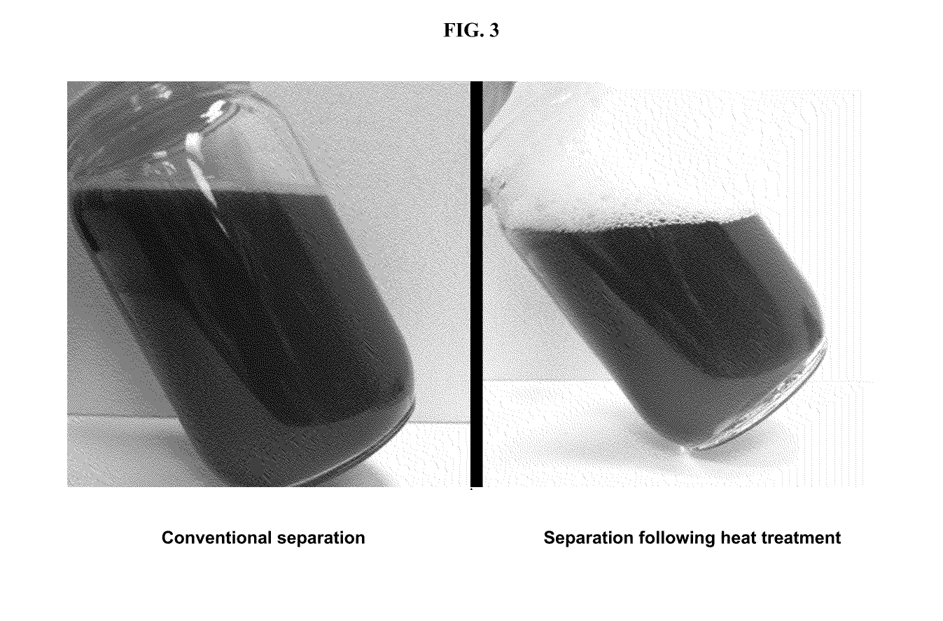

FIG. 3 shows pictures of the enzymatic hydrolysate after being subjected to this separation method, compared to an enzymatic hydrolysate centrifuged and filtered but not subjected to thermal treatment. The hydrolysate from the separation method in this Example (right-hand side of FIG. 3) is free of suspended dark solids and is more transparent. The conventional separation gives a hydrolysate (left-hand side of FIG. 3) is cloudy and filled with suspended fine particles.

This is corroborated by the total suspended solids content in the two hydrolysate liquor samples. The hydrolysate collected after conventional separation has 2.4% total suspended solids, while the liquor sample separated using the method of this Example contains only 0.12% total suspended solids, which is a 20-fold improvement in sugar syrup purity as measured by total suspended solids.

In this detailed description, reference has been made to multiple embodiments of the invention and non-limiting examples relating to how the invention can be understood and practiced. Other embodiments that do not provide all of the features and advantages set forth herein may be utilized, without departing from the spirit and scope of the present invention. This invention incorporates routine experimentation and optimization of the methods and systems described herein. Such modifications and variations are considered to be within the scope of the invention defined by the claims.

All publications, patents, and patent applications cited in this specification are herein incorporated by reference in their entirety as if each publication, patent, or patent application were specifically and individually put forth herein.

Where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially.

Therefore, to the extent there are variations of the invention, which are within the spirit of the disclosure or equivalent to the inventions found in the appended claims, it is the intent that this patent will cover those variations as well. The present invention shall only be limited by what is claimed.

What is claimed is:

1. A method for purifying a biomass hydrolysate comprising sugars and suspended particles, said method comprising centrifuging said biomass hydrolysate to generate a centrifuged hydrolysate, thermally treating said centrifuged hydrolysate to chemically or physically agglomerate at least a portion of said suspended particles, thereby generating a thermally treated hydrolysate, and filtering said thermally treated hydrolysate to remove agglomerated suspended particles, thereby generating a purified hydrolysate comprising said sugars.

2. The method of claim 1, wherein said biomass hydrolysate is obtained from enzymatic hydrolysis of pretreated lignocellulosic biomass.

3. The method of claim 2, wherein said pretreated lignocellulosic biomass is obtained from steam or liquid hot-water extraction of biomass.

4. The method of claim 2, wherein said pretreated lignocellulosic biomass is obtained from fractionation of biomass in the presence of water, a solvent for lignin, and an acid.

5. The method of claim 1, wherein said biomass hydrolysate is obtained from enzymatic or acidic hydrolysis of biomass-derived hemicelluloses.

6. The method of claim 1, wherein said biomass hydrolysate includes a first hydrolysate obtained from enzymatic hydrolysis of pretreated lignocellulosic biomass, and a second hydrolysate obtained from enzymatic or acidic hydrolysis of biomass-derived hemicelluloses.

7. The method of claim 6, wherein said biomass-derived hemicelluloses are derived from the same source of biomass as said pretreated lignocellulosic biomass.

8. The method of claim 1, wherein said thermally treating includes heating said centrifuged hydrolysate at a treatment temperature selected from about 50° C. to about 200° C. for a treatment time selected from about 10 minutes to about 8 hours.

9. The method of claim 8, wherein said thermally treating includes heating said centrifuged hydrolysate at said treatment temperature selected from about 80° C. to about 120° C. for said treatment time selected from about 30 minutes to about 2 hours.

10. The method of claim 1, wherein said method further includes introducing an additive to said biomass hydrolysate, said thermally treated hydrolysate, or said centrifuged hydrolysate, to assist in agglomeration of said suspended particles.

11. A method for purifying a biomass hydrolysate comprising sugars and suspended particles, said method comprising thermally treating said biomass hydrolysate to chemically or physically agglomerate at least a portion of said suspended particles, thereby generating a thermally treated hydrolysate, centrifuging said thermally treated hydrolysate to generate a centrifuged hydrolysate, and filtering said centrifuged hydrolysate to remove agglomerated suspended particles, thereby generating a purified hydrolysate comprising said sugars.

12. The method of claim 11, wherein said biomass hydrolysate is obtained from enzymatic hydrolysis of pretreated lignocellulosic biomass.

13. The method of claim 12, wherein said pretreated lignocellulosic biomass is obtained from steam or liquid hot-water extraction of biomass.

14. The method of claim 12, wherein said pretreated lignocellulosic biomass is obtained from fractionation of biomass in the presence of water, a solvent for lignin, and an acid.

15. The method of claim 11, wherein said biomass hydrolysate is obtained from enzymatic or acidic hydrolysis of biomass-derived hemicelluloses.

16. The method of claim 11, wherein said biomass hydrolysate includes a first hydrolysate obtained from enzymatic hydrolysis of pretreated lignocellulosic biomass, and a second hydrolysate obtained from enzymatic or acidic hydrolysis of biomass-derived hemicelluloses.

17. The method of claim 16, wherein said biomass-derived hemicelluloses are derived from the same source of biomass as said pretreated lignocellulosic biomass.

18. The method of claim 11, wherein said thermally treating includes heating said biomass hydrolysate at a treatment temperature selected from about 50° C. to about 200° C. for a treatment time selected from about 10 minutes to about 8 hours.

19. The method of claim 18, wherein said thermally treating includes heating said biomass hydrolysate at said treatment temperature selected from about 80° C. to about 120° C. for said treatment time selected from about 30 minutes to about 2 hours.

20. The method of claim 11, wherein said method further includes introducing an additive to said biomass hydrolysate, said thermally treated hydrolysate, or said centrifuged hydrolysate, to assist in agglomeration of said suspended particles.
